(19) United States
(12) Patent Application Publication
(10) Pub. No.: US 2021/0366017 A1
(43) Pub. Date: Nov. 25, 2021

(54) SYSTEM FOR PROVIDING BIG DATA BASED PRICE COMPARISON SERVICE USING TIME-SERIES ANALYSIS AND PRICE PREDICTION

(71) Applicant: Nature Mobility Co., Ltd., Jeju-si (KR)

(72) Inventor: Ju Sang LEE, Seoul (KR)

(73) Assignee: Nature Mobility Co., Ltd., Jeju-si (KR)

(21) Appl. No.: 17/032,763

(22) Filed: Sep. 25, 2020

(30) Foreign Application Priority Data
May 20, 2020 (KR) 10-2020-0060439

(51) Int. Cl. G06Q 30/06; G06Q 30/02; G06F 16/951

(52) U.S. Cl. CPC G06Q 30/0627; G06Q 30/0206; G06F 2216/03; G06Q 30/0645; G06F 16/951

(57) ABSTRACT

A big data-based price comparison service providing system using time-series analysis and price prediction is provided. A big data-based price comparison service providing system includes a user terminal and a price comparison service providing server including a big datafication unit, a database unit, and a search providing unit.

### CROSS-REFERENCE TO RELATED APPLICATIONS

This application claims the priority of Korean Patent Application No. 10-2020-0060439 filed on May 20, 2020, in the Korean Intellectual Property Office, the disclosure of which is incorporated herein by reference.

### BACKGROUND

### Field

The present disclosure relates to a big data-based price comparison service providing system using time-series analysis and price prediction, and provides a platform which informs a price comparison search result using at least one price fluctuation factor parameter and a price predicted by time-series analysis.

### Description of the Related Art

The growth of tourism industry has a direct and indirect clear effect on the employment rate and the GDP and also has a big economic ripple effect such as promotion of domestic demand or attraction of foreign capital. Rapid and rational decision-making is important for the sustainable growth and competitive advantage of the tourism industry. In addition to the necessity for demand prediction to predict a flight seat, when in the field of hotel rooms, the income opportunity may be lost due to lack of physical capacity and lack of labor caused by under-prediction. Research for a tourism demand prediction emphasizes the importance of the precise demand prediction for better decision making in the public sector and the private sector. A tourism demand predicting method is mainly classified into three methods: A quantitative method using the numbers as they are, a qualitative method which involves subjective judgement, and a method which appropriately combines the two methods. The quantitative predicting method includes time-series analysis and causal relationship analysis, and the qualitative predicting method includes a Delphi predicting method and a scenario setting method.

In this case, in addition to demand prediction, a method for predicting and comparing a traveling cost has been studied and developed. With regard to this, Korean Unexamined Patent Application Publication No. 10-2018-0058522 (published on Jun. 1, 2018) and Korean Registered Patent No. 10-1713155 (published on Mar. 7, 2017) disclose a configuration which predicts a price fluctuation rate for a country to visit by storing and using tourism big data, generates country-to-visit information relating a country where a tourist visits using tourist information, the big data and a price fluctuation rate, and provides the country-to-visit information to a tourist's terminal and a configuration which collects and manages rental car data for an available rental car list including a rental price, collects rental car demand information in accordance with a search request of a user who wants to use a rental car, collects a desired vehicle class, a price, and a demand quantity, calculates a calculated price by analyzing a demand and a schedule of a user, a desired price range, a real-time stock of a rental car company, and a reference value for available rental car supply information and a reference price, as variables, provides an adjusted price to the user together with a search result, and requests the search of price comparison for available rental car including a rental price for the desired rental vehicle class, respectively.

However, among the above-described configurations, according to the former configuration, even though the big data is analyzed, the analysis has not been performed according to a period which has the greatest fluctuation in the travel so that a high-peak season, a peak season, a normal season, an off-season, and the like are not considered and a resulting price fluctuation is not reflected at all. Further, according to the latter configuration, a real-time search traffic of the user is understood as a real-time demand so that a dummy such as an example that the user actually searches, but does not make a reservation is also counted as an actual real-time demand. Therefore, the person who actually wants to make a reservation unwillingly has to pay a premium price for the reservation due to the search attack. Therefore, there is a demand on the research and development on an analysis method which takes into account a unique characteristic of a travel package with a characteristic such as a price fluctuation which greatly depends on a season and a price prediction and analysis platform based thereon when the big data is analyzed.

### SUMMARY

An object of the present disclosure is to provide a big data-based price comparison service providing method using time-series analysis and price prediction which predicts a price fluctuation between reservation timings and provides information indicating whether a price proposed by a promotion is an appropriate price by performing both cross-sectional comparison corresponding to price comparison between companies in a tourism industry field including flight, accommodations, and rental cars and longitudinal comparison corresponding to time-series materials, builds a data model for a smart time-series price comparison service corresponding to a parameter such as a cause of the price fluctuation, a customer's search request, and a customer purchasing scenario based on the big data, proposes price prediction information even in the future when purchase information is not currently provided, extracts a parameter required for customer's search from a search item pattern and a list filtering method by observing a scenario which reaches product information desired by the customer by configuring the price fluctuation factors in various ways depending on the day of the week, seasons, regions, a vehicle class, a car model year, a difference between used days and a purchasing date, a type of company, and a rental period, and visualizes an analysis result corresponding thereto to intuitively identify the analysis result. However, objects to be achieved by various embodiments of the present disclosure are not limited to the technical objects as described above and other technical objects may be present.

In order to achieve the above-described technical object, an exemplary embodiment of the present disclosure includes a user terminal which inputs a search word including at least one of a vehicle class to rent, a region to rent, and a rental period and outputs a price comparison result of a predicted rental price corresponding to the input search word; and a price comparison service providing server including a big datafication unit which maps and stores at least one price fluctuation factor parameter and a rental car price corresponding to the at least one price fluctuation factor and builds big data, a database unit which performs data mining on the big data to perform a rental price prediction corresponding to a vehicle class, a region, and a period in accordance with at least one price fluctuation factor parameter to store the predicted rental price by mapping with the vehicle class, the region, and period, and at least one price fluctuation factor parameter, and a search providing unit which when any one search word of the vehicle class, the region, and the period is input from the user terminal, searches for result data corresponding to the search word by the database unit and when there is an attribute including at least one price fluctuation factor parameter in the vehicle class, the region, and the period, provides a price comparison result to the user terminal together with result data obtained by eliminating the price fluctuation factor parameter.

According to any one of the aspects of the present disclosure, it is possible to predict a price fluctuation between reservation timings and provide information indicating whether a price proposed by a promotion is an appropriate price by performing both cross-sectional comparison corresponding to price comparison between companies in a tourism industry field including flight, accommodations, and rental cars and longitudinal comparison corresponding to time-series materials, build a data model for a smart time-series price comparison service corresponding to a parameter such as a cause of the price fluctuation, a customer's search request, and a customer purchasing scenario based on the big data, propose price prediction information in the future when purchase information is not currently provided, extract a parameter required for customer's search from a search item pattern and a list filtering method by observing a scenario which reaches product information desired by the customer by configuring the price fluctuation factors in various ways depending on the day of the week, seasons, regions, vehicle classes, a car model year, a difference between used days and a purchase date, a type of company, and a rental period, and visualize an analysis result corresponding thereto to intuitively identify the analysis result.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view for explaining a big data-based price comparison service providing system using time-series analysis and price prediction according to an exemplary embodiment of the present disclosure;

FIG. 2 is a block diagram for explaining a price comparison service providing server included in the system of FIG. 1;

FIGS. 3A, 3B, 3C, 4A and 4B are views for explaining an exemplary embodiment in which a big data-based price comparison service using time-series analysis and price prediction according to an exemplary embodiment of the present disclosure is implemented; and

FIG. 5 is an operational flowchart for explaining a big data-based price comparison service providing method using time-series analysis and price prediction according to an exemplary embodiment of the present disclosure.

### DETAILED DESCRIPTION OF THE EMBODIMENT

Hereinafter, exemplary embodiments of the present disclosure will be described more fully hereinafter with reference to the accompanying drawings, so as to be easily carried out by those skilled in the art in the technical field to which the present disclosure belongs to. However, the present disclosure can be realized in various different forms, and is not limited to the exemplary embodiments described herein. Accordingly, in the drawings, in order to clearly describe the present disclosure, parts not related to the description are omitted. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, when a part includes an arbitrary element, it will be understood to imply the inclusion of stated elements but not the exclusion of any other elements. Further, it may be also understood that the presence or addition of one or more other features, numbers, steps, operations, elements, parts, or combinations thereof are not precluded in advance.

The terms “about or approximately” or “substantially” indicating a degree used throughout the specification are used as a numerical value or a meaning close to the numerical value when a unique manufacturing and material tolerance is proposed to the mentioned meaning and also used to prevent unscrupulous infringers from wrongfully using the disclosure in which precise or absolute numerical values are mentioned for better understanding of the present disclosure. Terms used throughout the specification, “˜ ing step” or “step of˜” do not mean “step for˜”.

Further, in the specification, the term “unit” includes a unit implemented by hardware, a unit implemented by software, and a unit implemented by both the hardware and the software. Further, one unit may be implemented using two or more hardwares or two or more units may be implemented by one hardware. However, the term “˜unit” is not limited to the software or the hardware but may be configured to be provided in an addressable storage medium or configured to reproduce one or more processors. Accordingly, as an example, “˜unit” includes components such as software components, object-oriented software components, class components, and task components, processes, functions, attributes, procedures, subroutines, segments of a program code, drivers, a firmware, a microcode, a circuit, data, database, data structures, tables, arrays, and variables. A function which is provided in the components and “˜units” may be combined with a smaller number of components and “˜units” or divided into additional components and “˜units”. Further, the components and “˜units” may be implemented to reproduce one or more CPUs in a device or a security multimedia card.

In the present specification, some of operations or functions which are described as being performed by a terminal or a device may also be performed by a server connected to the corresponding terminal or device instead. Likewise, some of the operations or functions described as being performed by the server may also be performed on a terminal or device connected to the server.

In the specification, a part of an operation or function of mapping or matching with a terminal may be interpreted as a meaning of mapping or matching a unique number of a terminal which is identification information of the terminal or personal identification information.

Hereinafter, the present disclosure will be described in detail with reference to the accompanying drawings.

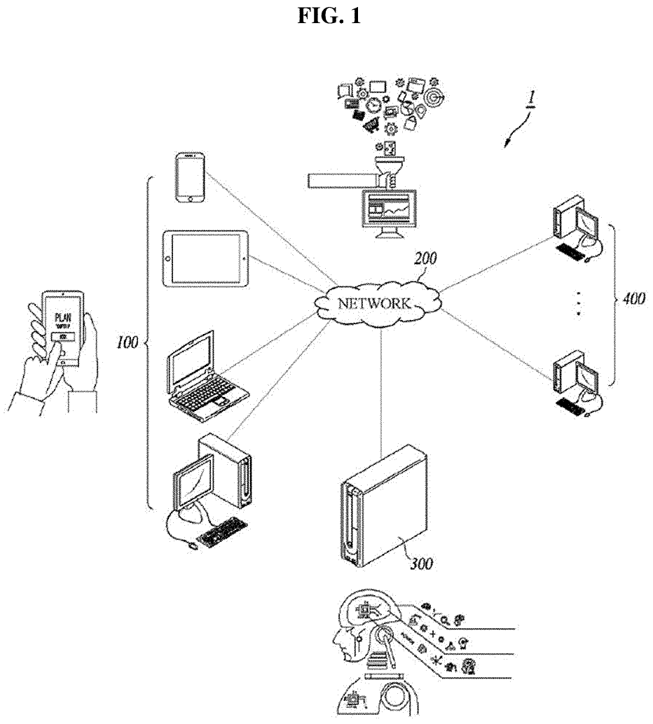

FIG. 1 is a view for explaining a big data-based price comparison service providing system using time-series analysis and price prediction according to an exemplary embodiment of the present disclosure. Referring to FIG. 1, the big data-based price comparison service providing system 1 using time-series analysis and price prediction may include at least one user terminal 100, a price comparison service providing server 300, and at least one rental car company terminal 400. However, the big data-based price comparison service providing system 1 using time-series analysis and price prediction of FIG. 1 is just one example of the present disclosure so that the present disclosure is not interpreted to be limited by FIG. 1.

In this case, the components of FIG. 1 are generally connected through a network 200. For example, as illustrated in FIG. 1, at least one user terminal 100 may be connected to the price comparison service providing server 300 through the network 200. The price comparison service providing server 300 may be connected to at least one user terminal 100 and at least one rental car company terminal 400 through the network 200. Further, at least one rental car company terminal 400 may be connected to the price comparison service providing server 300 through the network 200.

Here, the network refers to a connection structure in which information can be exchanged between respective nodes such as a plurality of terminals and servers, and examples of the network include a local area network (LAN), a wide area network (WAN), Internet (WWW: world wide web), a wired/wireless data communication network, a telephone network, a wired/wireless television communication network, and the like. Examples of the wireless data communication network include 3G, 4G, 5G, 3rd generation partnership project (3GPP), 5th generation partnership project (5GPP), long term evolution (LTE), world interoperability for microwave access (WIMAX), Wi-Fi, Internet, local area network (LAN), wireless local area network (Wireless LAN), wide area network (WAN), personal area network (PAN), radio frequency (RF), Bluetooth network, near-field communication (NFC) network, satellite broadcasting network, analog broadcasting network, digital multimedia broadcasting network (DMB), and the like, but are not limited thereto.

In the following description, it is obvious that the term “at least one” is defined as a term including a singular form and a plural form and even though the term “at least one” is not used, it is obvious that each component may be provided as a singular form or a plural form and it means a singular form or a plural form. Further, each component may be provided as a singular form or a plural form depending on the exemplary embodiments.

At least one user terminal 100 may be a terminal which inputs a search word corresponding to a desired condition and outputs a search result using a web page, an App page, a program, or an application related to a big data-based price comparison service using time-series analysis and price prediction. In this case, when the search result is output, the user terminal 100 may output not only just an actual search result, but also a search result based on a predicted price. Further, the user terminal lists, in order of lowest price, search results obtained by setting various price fluctuation factor parameters in addition to a search word of a desired condition to confirm which condition needs to be selected to rent a car at a cheapest price depending on the other price fluctuation factor and further to make a travel plan. For example, when the rental car is searched by the user terminal 100, if it is assumed that “Jeju Island” is input as a search word by setting only “region” as a condition, other conditions excluding “region”, for example, various price fluctuation factor parameters such as “date”, “rental period”, “the day of the week” are used to identify the “date”, “rental period”, and “day of the week” when the lowest price is available and confirm the lowest price. In this case, the user terminal 100 may search not only for the rental car, but also for a flight ticket and an accommodation. If “LA” is input as a search word for the region, the user terminal 100 may receive and output a date when the flight ticket to LA or the accommodation is provided at the lowest price from the price comparison service providing server 300.

Here, at least one user terminal 100 may be implemented by a computer which is accessible to a server or a terminal at a distance place through a network. Here, the computer may include, for example, a notebook computer, a desktop computer, a laptop computer, or the like in which a navigation and a web browser are loaded. In this case, at least one user terminal 100 may be implemented by a terminal which is accessible to a server or a terminal at a distance place through a network. At least one user terminal 100 may include all kinds of handheld wireless communication device which ensures portability and mobility, such as a navigation, a personal communication system (PCS), a global system for mobile communication (GSM), a personal digital cellular (PDC), a personal handyphone system (PHS), a personal digital assistant (PDA), an international mobile telecommunication (IMT)-2000, code division multiple access (CDMA)-2000, W-code division multiple access (W-CDMA), a wireless broadband internet (Wibro) terminal, a smart phone, a smart pad, and a tablet PC.

The price comparison service providing server 300 may be a server which provides a web page, an App page, a program, or an application of a big data-based price comparison service using time-series analysis and price prediction. The price comparison service providing server 300 may be a server which collects price fluctuation factor parameters such as a date, a region, whether it is a peak season, a day of the week, or seasons and a price through at least one price comparison site or web crawling to build big data. Further, the price comparison service providing server 300 may be a server which analyzes a pattern and a correlation between at least one price fluctuation factor parameter and the price from the built big data and stores a predicted price in the future by mapping with at least one price fluctuation factor parameter using a time-series analysis model. When a search word corresponding to any one condition is input from the user terminal 100, the price comparison service providing server 300 searches for a predicted price corresponding to the search word to generate a search result. In this case, when there is a price fluctuation factor parameter in the search word, the price comparison service providing server corrects a price by applying the price fluctuation factor parameter and transmits a search result based on the price predicted in accordance with the time-series analysis to the user terminal 100. Therefore, the price comparison service providing server 300 may allow a user to make a reservation for a rental car, an accommodation, and a flight at a lowest price by adjusting the price fluctuation factor parameter other than a condition desired by the user terminal 100.

Here, the price comparison service providing server 300 may be implemented by a computer which is accessible to a server or a terminal at a distance place through a network. Here, the computer may include, for example, a notebook computer, a desktop computer, a laptop computer, or the like in which a navigation and a web browser are loaded.

At least one rental car company terminal 400 may be a terminal of a rental car company which uses a web page, an App page, a program, or an application related to a big data-based price comparison service using time-series analysis and price prediction. In this case, when the exemplary embodiment is not limited to prediction of a rental car price, but expands to an accommodation or a flight, the rental car company terminal may be a terminal of at least one accommodation company or a terminal of an airline, or a server or a terminal of a price comparison site which provides a price of an accommodation or a flight. In this case, at least one rental car company terminal 400 may receive information such as the date, the vehicle class, and the region when there is a reservation request of the user terminal 100 through the price comparison service providing server 300 to set the reservation.

Here, at least one rental car company terminal 400 may be implemented by a computer which is accessible to a server or a terminal at a distance place through a network. Here, the computer may include, for example, a notebook computer, a desktop computer, a laptop computer, or the like in which a navigation and a web browser are loaded. In this case, at least one rental car company terminal 400 may be implemented by a terminal which is accessible to a server or a terminal at a distance place through a network. At least one rental car company terminal 400 may include all kinds of handheld wireless communication device which ensures a portability and a mobility, such as a navigation, a personal communication system (PCS), a global system for mobile communication (GSM), a personal digital cellular (PDC), a personal handyphone system (PHS), a personal digital assistant (PDA), an international mobile telecommunication (IMT)-2000, code division multiple access (CDMA)-2000, W-code division multiple access (W-CDMA), a wireless broadband internet (Wibro) terminal, a smart phone, a smart pad, and a tablet PC.

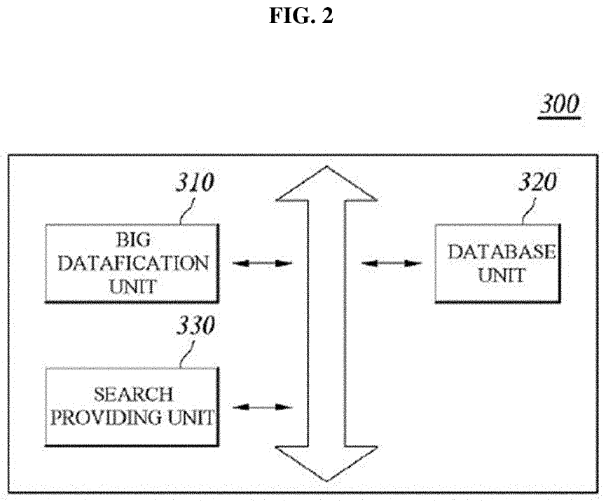

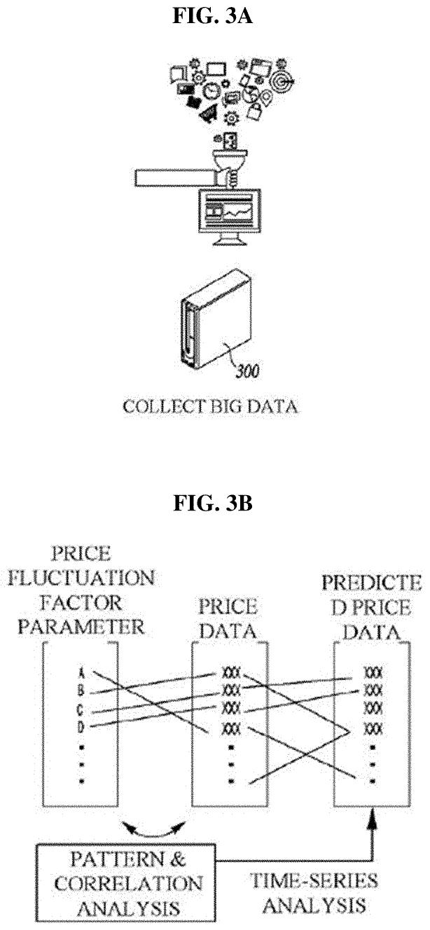

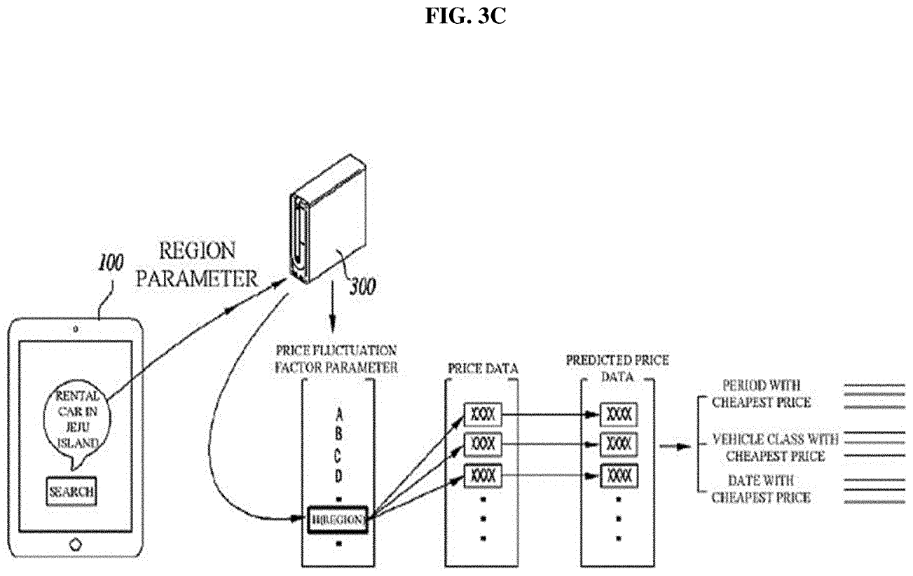

FIG. 2 is a block diagram for explaining a price comparison service providing server included in the system of FIG. 1 and FIGS. 3A, 3B, 3C, 4A and 4B are views for explaining an exemplary embodiment in which a big data-based price comparison service using time-series analysis and price prediction according to an exemplary embodiment of the present disclosure is implemented.

Referring to FIG. 2, the price comparison service providing server 300 may include a big datafication unit 310, a database unit 320, and a search providing unit 330.

When the price comparison service providing server 300 according to an exemplary embodiment of the present disclosure or another server (not illustrated) which interworks therewith transmits a big data-based price comparison service application, program, App page, web page, or the like using time-series analysis and price prediction to at least one user terminal 100 and at least one rental car company terminal 400, at least one user terminal 100 and at least one rental car company terminal 400 may install or open the big data-based price comparison service application, program, App page, web page, or the like using time-series analysis and price prediction. Further, a service program may be driven in at least one user terminal 100 and at least one rental car company terminal 400 using a script which is executed in the web browser. Here, the web browser is a program which enables a user to use the Web (WWW: world wide web) service and also refers to a program which receives and shows a hypertext described by the hypertext mark-up language (HTML) and for example, includes Netscape, Explorer, Chrome, and the like. Further, the application refers to an application program on the terminal and for example, includes App executed in the mobile terminal (smart phone).

Referring to FIG. 2, the big datafication unit 310 may map and store at least one price fluctuation factor parameter and a rental car price corresponding to at least one price fluctuation factor and build a big data. The big datafication unit 310 may perform pre-processing including storing of raw data including at least one price fluctuation factor and price data corresponding to at least one price fluctuation factor in a distributed and parallel manner, cleaning of unstructured data, structured data, and semi-structured data included in the stored raw data, and classifying as meta data and perform analysis including data mining on the pre-processed data to store the predicted price mapped with the price fluctuation factor, and visualize the analyzed data to output.

Text mining is a technique which extracts and processes useful information from unstructured/semi-structured text data based on a natural language processing technique. By means of the text mining technique, meaningful information is extracted from a vast text cluster, linkages with other information are identified, and a category of the text is found out or a result more than just information search may be obtained. By using this, in the price comparison service according to the exemplary embodiment of the present disclosure, a large capacity of language resources and statistical and regular algorithms may be used to analyze an identifier or a natural language which is input as a query and discover information hidden therein.

At this time, at least one price fluctuation factor parameter includes a day of the week, a season, a region, a vehicle class, a car model year, a difference between used days and a purchase date, a company type, and a rental period. When the weekends are included in the rental period, the day of the week acts as a price increase factor and when the season corresponds to a predetermined high peak season or straight holydays, the season acts as a price increase factor. With regard to the region, in the case of Jeju Island, in January to April and September to November, a lowest price is formed so that the region acts as a price decrease factor. The vehicle class may act as a price decrease factor or a price increase factor such that the older the car model year, the lower the rental price and the larger the vehicle class, the higher the rental price. With respect to the same used date, the used day acts as a price decrease factor such that the earlier the purchase date, the lower the price and in a predetermined high peak season, the used date acts as a factor which applies a weight to a price decrease factor. The company type acts as a price increase factor such that the larger the company, the higher the price and the rental period acts as a price decrease factor such that the longer the rental period, the lower the rental price per day. This is summarized as represented in the following Table 1. However, the price fluctuation factor parameter is not limited thereto and may be further added, deleted, or modified by big data analysis.

TABLE 1

| Price fluctuation factor | Explanation |
|---|---|
| Day of week | Acts as price increase factor if weekends are included in rental period |
| | In some companies, weekend price is also applied to Friday |
| Season/region | Summer vacation season (July to August) is high peak season |
| | so that highest price is provided |
| | The longer the holidays, the higher the price |
| | In Jeju-island, in January to April and September to |
| | November, lowest price is formed |
| Vehicle class/model year | The older the car model year, the lower the rental price |
| | The larger the vehicle class, the higher the rental price |
| Difference between used | With the same used days, the earlier the purchase date, the |
| days and purchase date | lower the price (difference is significant in high peak season) |
| Company | The larger the company, the higher the price |
| Rental period | The longer the rental period, the lower the rental price per day |

In this case, in order to research customer's demands, a parameter required for search of the customer may be extracted from a search item pattern, a list filtering method, and the like by observing a scenario which samples the ensured customer's search data to be reached as product information desired by the customer and an additional customer's product searching scenario may be created to derive a data item required for every scenario and provide an appropriate visualizing method. In this case, the customer's product searching scenario is as represented in the following Table 2, but is not limited thereto.

TABLE 2

| Product searching scenario | Necessary data |
|---|---|
| Select travel itinerary by identifying section | Line graph for comparing price by vehicle |
| where rental price of desired vehicle class is | class (based on previous year) according to |
| low | period selected by user |
| | Required information: period, vehicle class |
| Identify company which provides low rental | Line graph for comparing price for every |
| cost in period desired by user regardless of | rental company (based on previous year) |
| vehicle class | according to period selected by user |
| | Required information: period, company |
| Identify when it is cheapest to book when | Line graph for booking price for every |
| rental car reservation date is decided | reservation date with respect to date when |
| | rental car is used (based on previous year) |
| | Required information: date when rental car |
| | is used |

As a method for providing price information of related companies, a price trend service providing method of similar related companies is investigated to supplement and visualize a price fluctuation factor and user's demands and a data item required for a smart price information service is defined. The visualizing method for a smart price information service may use not only a static visualization method, but also, an inline method which also discloses a product list and an interactive visualization method which varies depending on the customer.

Further, the big datafication unit 310 may use data ensured by a rental car price comparison service which is currently being operated to collect rental car smart price information big data. Further, payment information which is collected in RDBMS from 2018 and search log data stored as a file are still being corrected so that the payment information and search log data may also be used. The data includes a search date with car search and payment information for approximately 50 rental car companies (a total of 8 areas including Seoul, Jeju, Gyeonggi, Jeonnam, Gangwon, Ulsan, Japan, and Guam and 51 companies and a total of 10,000 cars), a search result (a car model, a vehicle class, a company name, a rental starting date, a rental ending date, a rental price), and payment information (discounted price, an insurance cost, an actually paid amount, and a payment date). The system according to the exemplary embodiment of the present disclosure may use a module which collects data required for smart price information by utilizing a rental car affiliate API which is currently ensured and ensure a collection source by discovering an additional affiliate. Data may be collected by utilizing API communication or web crawling depending on the affiliate environment and a latest big data platform may be used to use the collected data as a source of the big data system. In this case, Hadoop distributed file system (HDFS) which easily expands a file system and minimizes data loss by recursively storing data may be used, but is not limited thereto.

In this case, the web crawler is a computer program which systematically and automatically browses the world wide web. A task performed by the web crawler is referred to as web crawling or spidering and is one type of a bot or a software agent. The web crawler mainly includes a regular web crawler and a distributed web crawler. A basic operation of the web crawler starts by fetching URL from an URL frontier module to fetch a web page of the corresponding URL using the HTTL protocol. Next, a web page is stored in a temporary repository of a fetch module, a text and a link are extracted from a parser module, and the text is sent to an Indexer. It is determined whether to add the link to the URL frontier while passing through Content Seen, URL filter, Duplication URL element modules. In this case, it is actually impossible to crawl all the web documents with the regular web crawler, so that a distributed web crawler may be further used.

The distributed web crawler is mainly divided into a centralized type and a P2P (or fully-distributed) type. The centralized distributed web crawler has a structure in which a URL manager serves as a server and the crawler serves as a client. When the crawler downloads the document and extracts an outlink URL to hand over the URL to the URL manager, the URL manager inspects whether the URL is a URL of the downloaded document to remove a redundant URL. That is, a part of the regular web crawler which duplicates the URL and manages the URL is performed by the URL manager instead. In contrast, in the P2P type, each crawler has a completely independent structure. In the P2P type, each crawler operates like a regular web crawler. Each crawler downloads the documents, extracts Outlink URL, and eliminates the URL redundancy, independently. To do this, the list of downloaded URLs which are managed by individual crawlers needs to be exclusive from each other. Otherwise, different crawlers may download the same document. In order to solve this problem, the individual crawlers may separately and exclusively manage URL domains to be downloaded. That is, a crawler manages only a URL which belongs to a domain to download and hands over the remaining URLs to the other crawlers so that the individual crawlers may independently operate.

Next, a web content needs to be extracted. A web content extracting technique provides a function of automatically extracting a product name, a creator, a posting date, a text, and detailed information in the text of a resell product which is a content to be utilized for information analysis from the web document. The web content extracting system is a device which automatically produces a rule of extracting contents to extract only contents and is configured by a rule generator which automatically generates a content extraction rule, a navigation content eliminator which eliminates a navigation content from a given web document, and a core content extractor which extracts a content by comparing a similarity of content extraction rule keywords.

The big datafication unit 310 may use a Hadoop framework for processing big data as described above. The big data cannot be stored and processed by one computer so that it is essential to utilize a distributed storage and parallel processing framework using a plurality of computers for analysis of big data. The Hadoop distributed file system and the MapReduce may be used to analyze the big data. First, the apache Hadoop of the Hadoop distributed file system is an open source-based framework for distributed computing that aims for reliability and scalability. The apache Hadoop is developed based on the study of the Google's MapReduce and Google file system and is being actively used to study the big data in recent years. Hadoop is designed for cooperative clustering of local computing and thousands of computers with storage resources and the Hadoop distributed file system (HDFS) is designed to operate with a fault tolerance in different types of machines and serves as a data repository of a Hadoop application which handles a massive amount of data sets. Since the HDFS handles data sets of terabytes or more, all files to be stored are distributed and duplicated in data blocks with the same size to be processed in parallel. The HDFS cluster is configured by a name node and a plurality of data nodes. The name node manages a file system attribute and a location of the file and the data nodes actually store divided data blocks.

The MapReduce model may be used as an algorithm which analyzes data in parallel by a plurality of computers and is suitable for processing a massive amount of data sets in a cluster configured by different types of machines. Therefore, the analysis mechanisms are transformed using a distribution property of the MapReduce to be applied to analysis for the entire data. Hadoop MapReduce is an effective open source-based tool which helps to develop a program using the MapReduce. An administrator divides a job to be worked through the Hadoop MapReduce and operates the massive amount of data which is distributed to be stored, in parallel. This operation is enabled by directly implementing Map and Reduce which are two user (administrator) definition functions provided by the Hadoop MapReduce in addition to a main function by the administrator. The Map function sequentially reads all data inputs and generates key-value pairs as an intermediate result value. Results of the map functions which are performed in parallel are divided into results with the same key and transmitted to the Reduce function. The Reduce function collects and processes the intermediate result values to generate a final result. Other tasks of the distributed parallel processing are automatically processed by the Hadoop MapReduce so that a programming accessibility may be increased. It is obvious that various platforms or collecting methods other than the collecting and processing methods and the platform described above may be used.

The database unit 320 performs data mining on the big data to predict a rental price corresponding to a vehicle class, a region, and a period in accordance with at least one price fluctuation factor parameter to store the predicted rental price by mapping with the vehicle class, the region, and period, and at least one price fluctuation factor parameter. In this case, the database unit 320 may predict the price using a time-series analysis algorithm. In this case, the database unit 320 manages and analyzes a massive amount of data which is generated with respect to the elapse of the time to enable the time-series big data analysis and improve the performance in the distributed processing analysis. When the big data is distributed to be stored in the distributed file system and analyzed by a parallel processing manner, a quick result may be efficiently derived. The Hadoop distributed file system and the Hadoop MapReduce are considered as representative environments thereof. When the distributed and stored time-series data is particularly divided into different files, in order to find a time-series analysis pattern, a time-series pattern may be analyzed and extracted as an event from the big data which may be distributed into a plurality of files to be stored.

A sequence form which is formed of continuous values measured at the same time interval is referred to as time-series data. Price data such as a rental car price is periodically changed and collected so that it has a time-series characteristic including date and time data in all records with continuity. Therefore, in order to generate a pattern based event, the time-series characteristic needs to be considered. In the case of the rental car data, not only the collected date, but also a date when the rental car data is generated are collected and when the rental car data is collected in real time to show a volatility, the collected date may be estimated as a generated date and a price in accordance with the time may also be collected. Since the rental car data is collected together with the time, the rental car data may be used as a core providing source of statistical information to extract an event which is price fluctuation in accordance with a rental car rental period, a fluctuation of the rental car price in accordance with the region, or time-continuous data-based price fluctuation factor parameter such as date or a day of the week.

The rental car big data having a time-series characteristic may be processed by the following two processing methods.

The first method is a method of sequentially processing the rental car big data in a single system. In an independent application to which a method of sequentially processing the rental car big data from the first to the last is applied, a method of extracting an event corresponding to a current specific pattern using a counter variable and a flag variable is effective. This application sequentially reads and decomposes one record for the entire data to acquire current price data. Next, whether the current price exceeds a reference price which is the same as an average price is observed. Simultaneously, in order to identify whether the current price is a price when an event such as a high peak season, a holiday, straight holidays, or long vacation is progressed, each flag of a time-series event such as a date, a special event, or a vacation is inspected to determine whether a new event is generated. Finally, information about the generated event is recorded in a result file.

The second method is a distributed parallel processing method using MapReduce. A program to which a distributed processing method of rental car big data using Hadoop MapReduce is applied generates an event from time-series data of rental car data managed by the Hadoop cluster. The Map function generates a partial event unit with (key, value) based on a price fluctuation factor parameter or a reference price. The generated partial events are collected such that partial events with the same key, that is, the same event are grouped with a format of (key, list<value 1, value 2, . . . >). The Reduce function generates an event meaningful to the user using a counter of each event while parsing lists which are sorted in the time order from the first to the last. Since the generated result is stored in the Hadoop cluster, the result needs to move to a local file system for individual usage.

In order to use the MapReduce for time-series big data, the rental car big data needs to be preprocessed first. First, a plurality of rental car data collection files with a small size is spliced. The HDFS and the MapReduce are optimized for storage and processing of a massive amount of file so that a plurality of input files with a small size degrades a processing performance of the MapReduce. As a size of each data chunk of a data node, at least tens of megabytes are required to achieve a better performance in terms of distributed processing. For example, if it is assumed that an average size of one one-day rental car data file is 3 MB, this is a very small size as an input file of the Hadoop MapReduce and delays the processing time. If a processing time of the MapReduce program and a processing time of an independent Java application which actually perform the same function are compared in a situation where there are many input files with a small size, the processing time of the MapReduce program is significantly longer. This is because the entire MapReduce processing time is extended due to a long standby time for management of a plurality of files and generation of each Map task. Therefore, the rental car data files with a small size are spliced to generate and use input files with a maximum size of 3.3 GB and a minimum size of 450 MB. Simultaneously, in order to allow the Map function to independently process the information of each record, an identifier of each car and at least one price fluctuation factor parameter identifier are inserted into all the records. Further, the type of data is optimized to easily parse the data in the Map function. For example, in an original rental car data file, date and time data are combined, but the date and the time data are separated through the pre-processing process and meaningless data such as “000” which fills the digits may be processed as “0”.

As a processing mechanism in the Hadoop cluster, data which is subjected to the pre-processing process to support the high performance of the big data processing is distributed to be stored in the HDFS. In order to generate an event from the massive amount of data with the time-series characteristic, a time-series MapReduce mechanism which considers a filtering pattern and secondary sorting may be applied. First, the filtering pattern of the MapReduce is one of basic MapReduce design patterns and simply evaluates and determines each record based on several conditions. The filtering pattern has an intention of filtering a record which is not an object of interest and maintaining a record which is an object of interest so that it is similar to “select where” of SQL. That is, a sub set of data to be analyzed is extracted. As examples of applications, there are Grep to find a text of interest, data cleaning to eliminate data which does not follow the format, and simple random sampling to perform representative analysis.

Next, secondary sorting of the MapReduce is performed. When the sorting is performed by a specific key, there may be a plurality of items with the same key. A main content of the secondary sorting is to set multiple keys which serve as a reference. For example, when the rental car prices are sequentially sorted by a region and a vehicle class, a list of rental cars in the same region is obtained first, and then the list is sorted by the vehicle class. In the MapReduce, results of the Map function are basically sorted by the key and then sent to the Reduce function. That is, a specific order of the result records with the same key is not guaranteed. In contrast, the secondary sorting of the MapReduce is to sort a list of values for a specific key which is an input of the Reduce in a specific order. This is not the sorting for the key so that it is different from an overall order sorting pattern. As examples of applications, there are an example that checks only a first record and a last record in the sorted list to identify a data range and an example that performs sorting by a time to provide a time line viewpoint of the data. In order to apply the secondary sorting to the time-series MapReduce mechanism, in addition to the implementation of the Map function and the Reduce function, a composite key class is generated and some methods for classification and sorting may be overridden.

The third method is to perform the time-series MapReduce mechanism. The Map function follows a filtering pattern to extract a partial event unit which configures a time-continuous event. specifically, in order to generate a peak season event which is a price fluctuation factor parameter, it is determined whether the price exceeds a price which is higher than an average price by a predetermined percent. A plurality of Map tasks generates a composite key with a car identifier, an event name, and a record generation time while executing the Map function, respectively, and processes a necessary part as a value to generate a partial event unit which is an intermediate result. These results are subjected to the secondary sorting to be sorted not only by the identifier of the cars, but also by the event name and the generation time to be transmitted to the Reduce tasks which perform the Reduce function. The Reduce task derives information configured by an identifier, an event type, a date, a time, and an event period to generate events with a time-series characteristic while reading the partial event unit list sorted by the time from the first to the last. Finally, the generated result is stored in the HDFS again.

Therefore, when at least one price fluctuation factor and the rental car price are mapped to be stored in the big data and a query corresponding to a search word of the user terminal 100 is input, the database unit 320 browses a rental car price corresponding to the search word. However, when there is at least one price fluctuation factor in the query, a predicted price which is already stored by being mapped to the price fluctuation factor may be output as a search result.

When any one search word of the vehicle class, the region, and the period is input from the user terminal 100, the search providing unit 330 searches for result data corresponding to the search word from the database unit 320. When there is an attribute including at least one price fluctuation factor parameter in the vehicle class, the region, and the period, the search providing unit may provide a price comparison result together with result data obtained by eliminating the price fluctuation factor parameter to the user terminal 100. For example, it is assumed that the user searches for a vehicle model called “Starex” as a search word. In this case, a prediction price in which time-series analysis is added to a price mapped to Starex may be output. However, the user limits the search word only to the vehicle class so that various prices may be output when conditions which are not limited, that is, price fluctuation factor parameters are considered. For example, an average price of the vehicle model “Starex” is 100,000 won per day and a predicted price which reflects a market price is 120,000 won. When a price fluctuation factor of the “region” is reflected, the price may be 80,000 won in Seoul and 60,000 won in Jeju Island. Further, when the price fluctuation factor of “date” is added, in the peak season, the price of Starex is 100,000 won in Seoul and 120,000 won in Jeju Island. As described above, prices according to various variables may be sorted in time-series manner by applying the price fluctuation factors other than the condition set by the user. For example, when the date is represented in an X-axis and prices for companies in Jeju Island are represented in a Y-axis, it is possible to know when to make a reservation with each company at the cheapest price.

Further, when a user A searches for Starex in Jeju Island by limiting in a period Z, if the price is higher than an average price because the period Z is a high peak season, the user is notified that the rental car may be rented with a cheaper price if the schedule is put forward or postpones for a period “H” other than the period “Z”, for example, a few more days such as two days before or three days later. In this case, the time-series analysis technique is used to perform the prediction by using past rental car data and is based on an assumption that the past price pattern is also available in the future. A weighted moving average method or an exponential smoothing method among the time-series analysis methods may be used, but the present disclosure is not limited to any one of them.

The weighted moving average method is expressed by the following Equation 1 in which Aw is a rental car price in a period w, Ww is a weight for the period w, and the weight is expressed by Equation 2. In this case, as described above, Aw may be replaced by a flight price and an accommodation price.

$$\begin{matrix}{F}_{w} = {W}_{w - 1} {A}_{w - 1} + {W}_{w - 2} {A}_{w - 2} + ⋯ + {W}_{w - n} {A}_{w - n} & [ Equation 1 ] \\ {\sum }_{i = w - 1}^{w - n} {W}_{i} = 1 & [ Equation 2 ]\end{matrix}$$

The Exponential smoothing method is expressed by the following Equation 3 in which Ae-1 is a rental car price for a period e and a is a smoothing constant (0≤a≤1) and the smoothing constant is represented by the following Equation 4. It is also obvious that the time-series analysis is also possible for the accommodation price and the flight price other than the rental car.

$$\begin{matrix}{F}_{e} = {F}_{e - 1} + a ( {A}_{e - 1} + {F}_{e - 1} ) & [ Equation 3 ] \\ a = \frac{{A}_{e - 1}}{{A}_{e - 2} + {A}_{e - 1}} & [ Equation 4 ]\end{matrix}$$

Here, among the machine learning techniques, a recurrent neural network which is suitable for time-series data learning and prediction is used to apply the price prediction model. The recurrent neural network is an artificial neural network model which is developed to transmit a state at a specific point of time together with data which is newly input to an input point where a state of a next point of time is generated. Therefore, time information between data may be considered so that the recurrent neural network is appropriate to learn and predict time-series data. Specifically, various modified techniques such as an RNN-LSTM (long short-term memory) which is a conversion model of the recurrent neural network developed to avoid the vanishing gradient problem during the data learning of the recurrent neural network model have been developed to be applied to various problems. In the method according to the exemplary embodiment of the present disclosure, various modified techniques of the recurrent neural network are applied and evaluated to provide a price prediction comparison service.

In the recurrent neural network, data input at every time step and a state in a previous time step are input to create a new state and the price is predicted using the new state. During the price prediction, the number of days in the past input at every time step has a significant impact on the price prediction performance. In addition, a learning rate and the number of learning times of the recurrent neural network model are also variables which affect the learning. Therefore, a value with the smallest root mean square error (RMSE) which is used as a performance measure while changing parameter values (price fluctuation factor parameters) may be selected as parameter values of the recurrent neural network model according to an exemplary embodiment of the present disclosure. Further, in order to avoid the vanishing gradient problem, one of LSTM cell and GRU cell which are recurrent neural network models may be selected. Both two techniques supplement the long-term memory loss of the recurrent neural network. The GRU cell has a better learning rate and a better prediction performance than the LSTM as the number of data types to learn is increased.

The price prediction may help to make a decision to rent a rental car. There are two types of decision making states: decision making for “purchase” to immediately purchase rental of the rental car and “waiting” to watch the fluctuation of the price without purchasing. The decision making for purchasing or waiting for rental of the rental car may be supported based on the learned price prediction model. A criterion for decision making in the decision making support model may be price prediction for one week from the current point of time. Several rules may be applied to support the decision making depending on a criterion of identifying a price fluctuation trend. The decision making may be supported by the number of days when a price exceeds the price on the present date, in the next one week, one month, or several months from the present date. If the price is continuously increased in the future from the present point of time, the user may make a reservation for the rental car at the present point of time and if the price consistently drops, the user may make a reservation for the rental car based on the future time. Similarly, it may help to decide an intention of purchase when to book the flight or the accommodation, where to travel, or what date the user will book a flight ticket.

In the meantime, the big datafication unit 310 may collect and store at least one price fluctuation factor parameter by mapping with the flight price and the accommodation price, in addition to the rental price. In this case, at least one price fluctuation factor parameter of the flight price includes a season, a using period, a departure date, a departure time, whether to layover, a reservation class, and a total flight time. At least one price fluctuation factor parameter of the accommodation price includes the day of the week, consecutive stays, a season, a star rating, and a region. The detailed price fluctuation factor is summarized in the following Table 3 and a scenario of the user to search for an accommodation and a flight ticket is summarized in Table 4.

TABLE 3

| Product class | Price fluctuation factor | Explanation |
|---|---|---|
| Flight ticket | Season | Fare varies depending on certain season which |
| | | is divided into high peak season, peak season, |
| | | and off-season (ex. In April and July which are |
| | | off-season, maximum fare difference is almost double) |
| | Using period | The shorter the period, the lower the fare |
| | Departure date | When book 5-6 month before the departure |
| | | date, fare tends to be cheaper |
| | Departure time | Flight ticket departing in the morning is |
| | | cheaper than flight ticket departing in the afternoon |
| | Layover | Ticket with layover is cheaper and the more the |
| | | number of stops, the cheaper the fare |
| | Reservation class | Price is higher in the order of first class, |
| | | business class, and economy class |
| | Total flight time | The shorter the total flight time, the higher the fare |
| Accommodation | Day of the week | When weekends are included, price is high |
| | | Among the week days, price on Wednesday is lower |
| | Consecutive stays | The longer the stay, the lower the price per night |
| | Season | Price is high in peak season between July and |
| | | September and December and January when |
| | | the number of tourists rises |
| | | Price is high in special event season such as |
| | | Olympic, Music Festival, and Sports tournament |
| | Star rating | The higher the star rating of hotel, the higher |
| | | the service quality and the price |
| | Region | Price is high in region with high population |
| | | density and in famous tourist spot |

TABLE 4

| Product class | Product search scenario | Required data |
|---|---|---|
| Flight ticket | It is possible to know when | Line graph for reservation price (based |
| | to book flight ticket at | on previous year) for every reservation |
| | lowest price | date for departure, destination, and |
| | | departing date and time |
| | | Required information: departure, |
| | | destination, departing date and time |
| Accommodation | It is possible to make | Line graph for reservation price for |
| | reservation for | every reservation date for region and |
| | accommodation by | check-in date (based on previous year) |
| | checking date when | Required information: Region, Check-in date |
| | cheapest price is available | |
| | based on check-in date | |

When the big data collection range is expanded from the rental car to the field of the flight ticket and the accommodation, the flight ticket data may be collected using Amadeus which is being used by Korean Air and Saver which is being used by Asiana Airlines, among global distribution system (GDS: global major flight reservation and selling system) companies. The accommodation service is associated with various web services which provide an accommodation price comparison service to provide data by API and crawling manner and is as represented in the following Table 5.

TABLE 5

| Product class | Data collection range |
|---|---|
| Flight ticket | Gradually expand to routes of all domestic and international airlines |
| | after applying Gimpo-Jeju route of Korean Air and Asiana Airlines (all |
| | available data which can be collected using Amadeus and Saver GDS) |
| Accommodation | Sequentially apply to overseas hotels after applying domestic affiliate |
| | and accommodation companies whose data can be collected by web |
| | crawling. Collection range is expanded by affiliation |

Through the price prediction by means of the big datafication and time-series analysis, when the user terminal 100 inputs a search word including at least one of a vehicle class to rent, a region to rent a car, and a rental period, a price comparison result of a predicted rental price corresponding to the input search word may be output. It is obvious that the present embodiment is not limited to the rental car, but is also applicable to the accommodation and the flight.

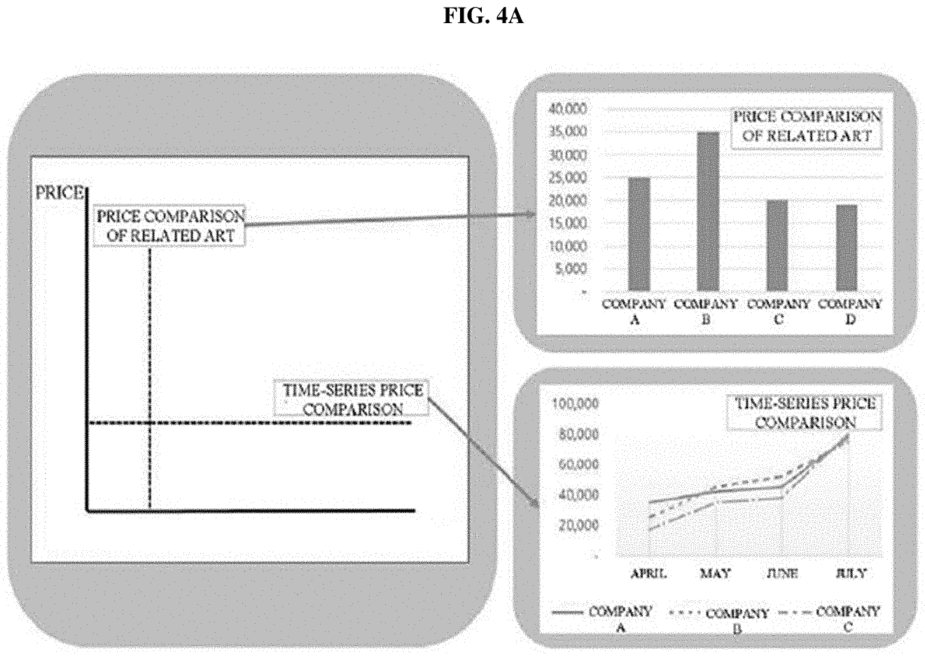

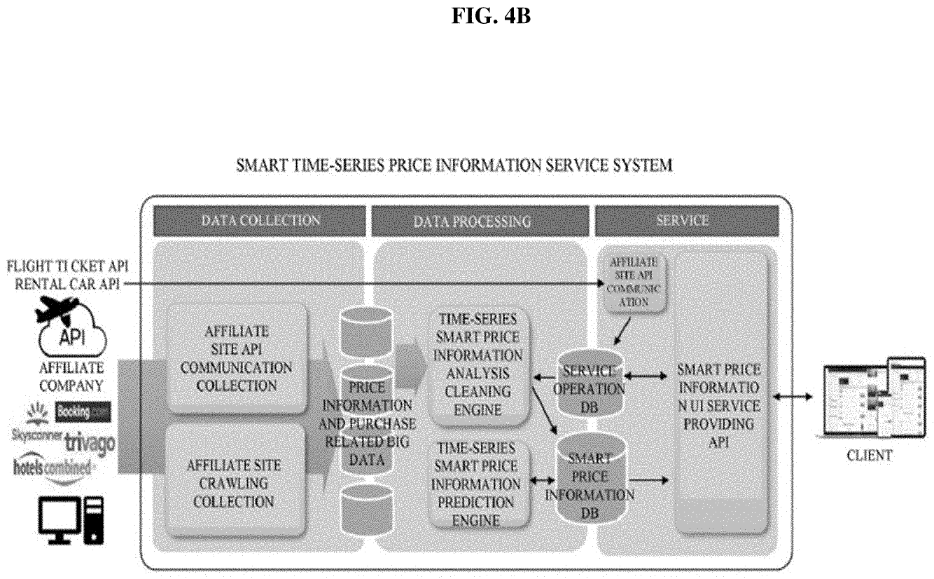

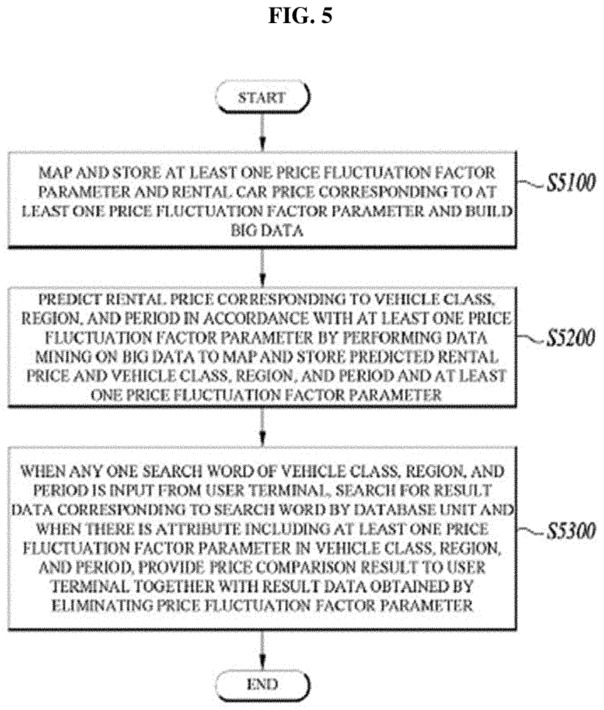

Hereinafter, an operation process in accordance with a configuration of a price comparison service providing server of FIG. 2 described above will be described in more detail with reference to FIGS. 3A, 3B, 3C, 4A and 4B. However, it is obvious that the exemplary embodiment is just one of various exemplary embodiments of the present disclosure, but the present disclosure is not limited thereto.

Referring to FIG. 3, (a) the price comparison service providing server 300 collects information of a rental car price through at least one company or site to build big data and (b) selects a price fluctuation factor parameter and then stores the price fluctuation factor parameter by mapping with price data and generates prediction price data through time-series analysis. Further, (c) the price comparison service providing server 300 fixes a condition included in a search word when the search word which limits any one condition is input from the user terminal 100 and then outputs price comparison data with another price fluctuation factor parameter as a variable to a time-series graph, and provides a price comparison result.

Referring to FIG. 4A, the price comparison according to the related art is performed for each company at the present time or shows just a price change over time. In contrast, according to the exemplary embodiment of the present disclosure, the price comparison for each company and the price change over time are comprehensively analyzed to show time-series prediction data by date and performs analysis by adding a condition such as a company or a region to enhance the precision of the prediction data.

Currently, domestic shopping malls provide a function such as purchase preference by age groups, a trend of lowest price, the number of registered products, product recommendations using the above-mentioned information. However, the tourism industry (rental cars, flight tickets, and accommodations) has characteristics in that the price difference is significant depending on the peak season or the off-season and a price change range is large depending on the reservation timing. Further, the price change range is significant depending on the reservation time and the reservation timing so that information which is currently being provided, such as the purchase preference by age groups, the trend of lowest price, and the number of registered products, is insufficient when a customer considers whether to buy by comparing the prices. Accordingly, according to the present disclosure, information for predicting a price change between reservation timings and indicating whether the price proposed by the promotion is appropriate may be provided by combining and analyzing cross-sectional data and longitudinal (time-series) data, rather than simple information (a lowest price of the price with respect to a predetermined data point of time) provided by the related art.

The usefulness of time-series data and the accuracy of the prediction are ensured by a precise data model based on accumulated experience knowledge and data. Even though simple time-series data such as a monthly lowest price, an intermediate price, an average price, and a highest price are valuable, in order to satisfy the requirements of the consumer, precise data modeling is necessary. Therefore, it is necessary to precisely analyze the price fluctuation factor. For example, in February, in the case of the tourism industry, the price difference is caused by the position of Lunar New Year. When there are many overseas tourists, it is also necessary to consider special seasons in foreign countries. For example, Chinese New Year and Japanese golden week in May become a price fluctuation factor parameter. Further, rather than the date, the day of the week, the service using period (for example, price reduction for usage for three days or longer), a difference between the service usage date and the purchase date (cheaper when purchasing six months earlier), and the like need to be precisely analyzed as price fluctuation factors. A precise data model may be built by data accumulated during the operation of the rental car price comparison service and a precise analysis result may be provided therethrough.

As illustrated in FIG. 4B, a smart price comparison service according to an exemplary embodiment of the present disclosure which provides a time-series price fluctuation analyzing and visualizing service by utilizing big data may provide time-series smart price information for a product which has a big price fluctuation depending on a season or a date, such as a rental car, a flight, and an accommodation to ensure price transparency and help customers to make a reasonable decision for purchase, build a data model for a smart time-series price comparison service based on a factor of the price fluctuation, a customer's search demand, and a customer's purchase scenario, collect product purchase information and customer's purchase information which are distributed in various forms by utilizing a latest big data technique, efficiently clean smart price comparison data, and propose price prediction information for the future when the purchase information is not currently provided, by utilizing the built smart price information.

Contents of the big data-based price comparison service providing method using time-series analysis and price prediction of FIGS. 2 to 4 which have not been described are the same as the description of the big data-based price comparison service providing method using time-series analysis and price prediction which has been carried out with reference to FIG. 1 or easily inferred from the description so that the description thereof will be omitted.

FIG. 5 is a view illustrating a process of transmitting and receiving data between components included in a big data-based price comparison service providing system using time-series analysis and price prediction of FIG. 1 according to an exemplary embodiment of the present disclosure. Hereinafter, an example of a process of transmitting and receiving data between the components will be described with reference to FIG. 5, but it is obvious to those skilled in the art that the present disclosure is not interpreted to be limited to the exemplary embodiment and the process of transmitting and receiving data illustrated in FIG. 5 may vary depending on the above-described various exemplary embodiments.

Referring to FIG. 5, the price comparison service providing server maps and stores at least one price fluctuation factor parameter and a rental car price corresponding to at least one price fluctuation factor parameter and builds big data in step S5100.

The price comparison service providing server performs data mining on the big data to perform a rental price prediction corresponding to a vehicle class, a region, and a period in accordance with at least one price fluctuation factor parameter to store the predicted rental price by mapping with the vehicle class, the region, and period, and at least one price fluctuation factor parameter in step S5200 and when any one search word of the vehicle class, the region, and the period is input from the user terminal, result data corresponding to the search word is searched by the database unit. When there is an attribute including at least one price fluctuation factor parameter in the vehicle class, the region, and the period, a price comparison result is provided to the user terminal together with result data obtained by eliminating the price fluctuation factor parameter in step S5300.

The order between the above-described steps S5100 to S5300 is just an example, but is not limited thereto. That is, the order between the above-described steps S5100 to S5300 may be changed and some of the steps may be simultaneously performed or omitted.

Contents of the big data-based price comparison service providing method using time-series analysis and price prediction of FIG. 5 which have not been described are the same as the description of the big data-based price comparison service providing method using time-series analysis and price prediction which has been carried out with reference to FIGS. 1 to 4 or easily inferred from the description so that the description thereof will be omitted.

The big data-based price comparison service providing method using time-series analysis and price prediction according to the exemplary embodiment described with reference to FIG. 5 may be implemented as a recording medium including an application executed by a computer or an instruction which can be executed by a computer such as a program module. The computer-readable medium may be an arbitrary available medium which is accessed by a computer and includes all of a volatile and non-volatile medium, a removable and non-removable medium. Further, the computer-readable medium may include all of a computer storage medium. The computer storage medium includes all of a volatile and non-volatile, a removable and non-removable medium which is implemented by an arbitrary method or a technique for storing information, such as a computer-readable command, a data structure, a program module, and other data.

The above described big data-based price comparison service providing method using time-series analysis and price prediction according to the exemplary embodiment of the present disclosure may be executed by an application (including a program included in a platform, an operating system, or the like installed as default in the terminal) which is installed as default in a terminal or executed by an application (that is, a program) which is directly installed in a master terminal by means of an application providing server such as an application store server, an application, or a web server related to the corresponding service, by a user. In this meaning, the above-described big data-based price comparison service providing method using time-series analysis and price prediction according to the exemplary embodiment of the present disclosure may be implemented by an application (that is, a program) which is basically installed in the terminal or is directly installed by the user and may be recorded in a computer-readable recording medium such as a terminal.

The above description of the present disclosure is illustrative only and it is understood by those skilled in the art that the present disclosure may be easily modified to another specific type without changing the technical spirit of an essential feature of the present disclosure. Thus, it is to be appreciated that embodiments described above are intended to be illustrative in every sense, and not restrictive. For example, each component which is described as a singular form may be divided to be implemented and similarly, components which are described as a divided form may be combined to be implemented.

The scope of the present disclosure is represented by the claims to be described below rather than the detailed description, and it is to be interpreted that the meaning and scope of the claims and all the changes or modified forms derived from the equivalents thereof come within the scope of the present disclosure.

What is claimed is:

1. A big data-based price comparison service providing system using time-series analysis and price prediction, the system comprising:
a user terminal which inputs a search word including at least one of a vehicle class to rent, a region to rent, and a rental period and outputs a price comparison result of a predicted rental price corresponding to the input search word; and
a price comparison service providing server including a big datafication unit which maps and stores at least one price fluctuation factor parameter and a rental car price corresponding to the at least one price fluctuation factor and builds big data, a database unit which performs data mining on the big data to perform rental price prediction corresponding to a vehicle class, a region, and a period in accordance with the at least one price fluctuation factor parameter to store the predicted rental price by mapping with the vehicle class, the region, and period, and the at least one price fluctuation factor parameter, and a search providing unit which when any one search word of the vehicle class, the region, and the period is input from the user terminal, searches for result data corresponding to the search word by the database unit and when there is an attribute including the at least one price fluctuation factor parameter in the vehicle class, the region, and the period, provides a price comparison result to the user terminal together with result data obtained by eliminating the price fluctuation factor parameter.

2. The price comparison service providing system according to claim 1, wherein the at least one price fluctuation factor parameter includes a day of the week, a season, a region, a vehicle class, a car model year, a difference between used days and a purchase date, a company type, and a rental period, when weekends are included in the rental period, the day of the week acts as a price increase factor, when the season is a predetermined high peak season, or holidays or straight holidays are long, the price increases so that the season acts as a price increase factor, in January to April and September to November, a lowest price is formed in Jeju Island so that the region acts as a price decrease factor, the older the car model year, the lower the rental price and the larger the vehicle class, the higher the rental price so that the vehicle class acts as a price decrease factor and a price increase factor, for the same used days, the earlier the purchase date, the lower the price so that the used days act as a price decrease factor and in a predetermined high peak season, the used days act as a factor which applies a weight to a price decrease factor, the larger the company, the higher the price so that the company acts as a price increase factor, and the longer the rental period, the lower the rental price per day so that the rental period acts as a price decrease factor.

3. The price comparison service providing system according to claim 1, wherein the database unit predicts a price using a time-series analysis algorithm.

4. The price comparison service providing system according to claim 1, wherein when the at least one price fluctuation factor and the rental price are mapped to be stored in the big data and a query corresponding to a search word of the user terminal is input, the database unit searches for a rental price corresponding to the search word and when there is the at least one price fluctuation factor in the query, a prediction price which is already mapped to the price fluctuation factor to be stored is output as a search result.

5. The price comparison service providing system according to claim 1, wherein the big datafication unit collects and stores a flight ticket price and an accommodation price by mapping with the at least one price fluctuation factor parameter, in addition to the rental price.

6. The price comparison service providing system according to claim 5, wherein the at least one price fluctuation factor parameter of the flight ticket price includes a season, a using period, a departure date, a departure time, whether to layover, a reservation class, and a total flight time and the at least one price fluctuation factor parameter of the accommodation price includes a day of the week, consecutive stays, a season, a star ranking, and a region.

7. The price comparison service providing system according to claim 1, wherein the big datafication unit performs pre-processing including storing of raw data including the at least one price fluctuation factor and price data corresponding to the at least one price fluctuation factor in a distributed and parallel manner, cleaning of unstructured data, structured data, and semi-structured data, and classifying to meta data and performs analysis including data mining on pre-processed data to store the predicted price mapped with the price fluctuation factor, and visualizes the analyzed data to output.
